(19) United States
(12) Patent Application Publication
(10) Pub. No.: US 2016/0060491 A1
(43) Pub. Date: Mar. 3, 2016

(54) Pigment Material and Metal Oxide Mixed Adhesive and Colorable Heat Ray Screening Carbon Ceramic Film using the Same

(71) Applicant: Rayno Window Film Inc., Orange, CA (US)

(72) Inventors: Jung Hyoung Lee, lncheon (KR); Jae Heon Jeong, Kimpo (KR); Jae Myung Kim, Kimpo (KR); Kyung Hwan Moon, Seoul (KR); Hyun Soo Cha, lncheon (KR)

(73) Assignee: Rayno Window Film Inc.

(21) Appl. No.: 14/835,729

(22) Filed: Aug. 26, 2015

(30) Foreign Application Priority Data
Aug. 27, 2014 (KR) 10-2014-0112295

(51) Int. Cl. C09J 11/04; B32B 27/08; B32B 7/12; C04B 35/52; C09J 11/06

(52) U.S. Cl. CPC C09J 11/04; C04B 35/52; C09J 11/06; B32B 7/12; B32B 27/08; B32B 2255/10; B32B 2255/26; B32B 2307/304; B32B 2451/00

(57) ABSTRACT

The present disclosure relates to an adhesive including a functional coating layer formed by mixing three or more materials such as carbon, ceramics, and a transparent pressure sensitive adhesive (PSA) at a predetermined ratio, in which a pigment material and a metal oxide are mixed, and a colorable heat ray screening carbon-ceramic film using the adhesive. According to one embodiment, the adhesive includes 20 to 90 wt % of a pigment material adhesive and 10 to 80 wt % of a metal oxide adhesive with respect to the total weight of the adhesive.

### CROSS-REFERENCE TO RELATED APPLICATION

Pursuant to 35 U.S.C. §119(a), this application claims the benefit of earlier filing date and right of priority to Korean Application No. 10-2014-0112295, filed on Aug. 27, 2014, the contents of which is incorporated by reference herein in its entirety.

### FIELD OF THE DISCLOSURE

The present disclosure relates to an adhesive in which a pigment material and a metal oxide are mixed, and a colorable heat ray screening carbon-ceramic film using the same.

### BACKGROUND OF THE DISCLOSURE

In general, a colored film is a film used for the purpose of decoration, selection of the wavelength of incident light, prevention of transillumination from outside, and the like in vehicles, buildings, packaging materials, display materials and the like, and is colored with a predetermined color. For the colored film, excellent clarity, light resistance, color fading resistance, stability and the like are generally required.

Such colored film generally includes a base film layer, a pigment layer, an adhesive layer, and the like, and a pigment layer and a bonding layer may also be additionally provided in the colored film, but a colored film, which achieves more simplified layers by making the pigment layer and the bonding layer as one layer, has been developed. Such colored film is disclosed in Korean Registered Patent No. 10-0276094. However, the patent describes that a colorant is included in an adhesive layer, but the dispersion efficiency of the colorant within the adhesive layer deteriorates, and also that the colorant fails to exhibit a function such as screening UV rays.

In order to solve the problems, Korean Registered Patent No. 10-1089630 was contrived. A pigmentable adhesive according to the patent includes 1 to 30 wt % of a pigment dispersion and 70 to 99 wt % of an adhesive with respect to the total weight of the pigmentable adhesive. The pigment dispersion includes 1 to 10 wt % of carbon black, 1 to 10 wt % of the pigment, 5 to 20 wt % of an acrylic dispersant, and 65 to 85 wt % of an organic solvent with respect to the total weight of the pigment dispersion. For the acrylic dispersant, one or more are selected from the group consisting of a terpolymer of 2-ethylhexyl acrylate, methacryl 2-hydroxyl acrylate, and methacrylic acid, and tetrabutylammonium 3-chlorobenzoate. Thus the pigment dispersibility in the adhesive is rather high that the liquid conglomeration does not occur in the adhesive, and as a result, clarity is high, workability is excellent, and effects of screening infrared rays are also excellent. Further, the pigment layer and the adhesive layer form a single layer to have a simple colored film structure and secure a simple fabrication process. The base film layer and the pigment layer are not easily separated since the pigment layer in the colored film disclosure according to the patent is not exposed to the outer surface, and thus, discoloration or color omission rarely occurs even though the colored film is brought into contact with an organic solvent, thus resulting in excellent solvent resistance and durability.

However, the foregoing product has a problem in manufacturing a pigment colored film so as to have a low haze which exceeds a fixed haze of a film in which a pigment is used. Further, there is a problem in that it is difficult to efficiently screen infrared rays because it is impossible to mix metal oxides.

### SUMMARY OF THE DISCLOSURE

Accordingly, the present disclosure has been contrived to solve the aforementioned problems, and an object of the present disclosure is firstly to provide a pigment material adhesive for manufacturing a pigment colored film having a low haze which passes the bounds of a fixed haze of a film in which a pigment is used; is secondly to provide a metal oxide adhesive which may be mixed with a metal oxide so as to add an efficient capability of screening infrared rays to a pigment film having good light resistance; and is thirdly to provide an adhesive in which the pigment material and the metal oxide are mixed and a colorable heat ray screening carbon-ceramic film using the same by mixing the pigment material adhesive and the metal oxide adhesive for use as a functional adhesive, thus reducing the number of fabrication processes the current wet coating-type heat screening films employ, and thereby improving convenience and efficiency of the process.

The adhesive in which the pigment material and the metal oxide are mixed according to the present disclosure includes 20 to 90 wt % of the pigment material adhesive and 10 to 80 wt % of the metal oxide adhesive with respect to the total weight of the adhesive in which the pigment material and the metal oxide are mixed. The pigment material adhesive includes 1 to 50 wt % of a pigment dispersion and 50 to 99 wt % of a glue material with respect to the total weight of the pigment material adhesive, in which the pigment dispersion includes 1 to 10 wt % of carbon black, 1 to 10 wt % of a pigment, 5 to 20 wt % of a dispersant, 65 to 85 wt % of an organic solvent with respect to the total weight of the pigment dispersion. The metal oxide adhesive includes 1 to 60 wt % of a metal oxide dispersion and 40 to 99 wt % of the glue material with respect to the total weight of the metal oxide adhesive, in which the metal oxide dispersion includes 1 to 40 wt % of the metal oxide, 5 to 30 wt % of a dispersant, and 30 to 85 wt % of an organic solvent with respect to the total weight of the metal oxide dispersion.

A colorable heat ray screening carbon-ceramic film according to the present disclosure includes a base film layer, and a functional bonding layer composed of a pigment material adhesive and a metal oxide adhesive from the top. As described above, the adhesive in which the pigment material and the metal oxide are mixed and the colorable heat ray screening carbon-ceramic film using the same according to the present disclosure have an advantage in that the pigment material adhesive for manufacturing the pigment colored film having the low haze may be provided by using a carbon-ceramic adhesive formed by mixing three or more materials such as carbon, ceramics, and transparent PSA at a predetermined ratio.

In addition, there is an advantage in that it is possible to provide a pigment material adhesive for manufacturing the pigment colored film having good light resistance and excellent infrared ray screening properties. Furthermore, there is an advantage in that the number of processes may provide the pigment material adhesive for manufacturing the pigment colored film in which convenience and efficiency of the process are improved. Further scope of applicability of the present application will become more apparent from the detailed description given hereinafter. However, it should be understood that the detailed description and specific examples, while indicating preferred embodiments of the disclosure, are given by way of illustration only, since various changes and modifications within the spirit and scope of the disclosure will become apparent to those skilled in the art from the detailed description.

### BRIEF DESCRIPTION OF THE DRAWINGS

The accompanying drawings, which are included to provide a further understanding of the disclosure and are incorporated in and constitute a part of this specification, illustrate exemplary embodiments and together with the description serve to explain the principles of the disclosure. In the drawings:

FIG. 1 is a cross-sectional view of an infrared ray screening film in the related art.

FIG. 2 is a cross-sectional view of a colorable heat ray screening carbon-ceramic film having a 1-ply structure, which uses an adhesive in which a pigment material and a metal oxide are mixed, according to the present disclosure.

FIG. 3 is a cross-sectional view of a colorable heat ray screening carbon-ceramic film having a 2-ply structure, which uses an adhesive in which a pigment material and a metal oxide are mixed, according to the present disclosure.

FIG. 4 is a cross-sectional view of a colorable heat ray screening carbon-ceramic film having a 3-ply structure, which uses an adhesive in which a pigment material and a metal oxide are mixed, according to the present disclosure.

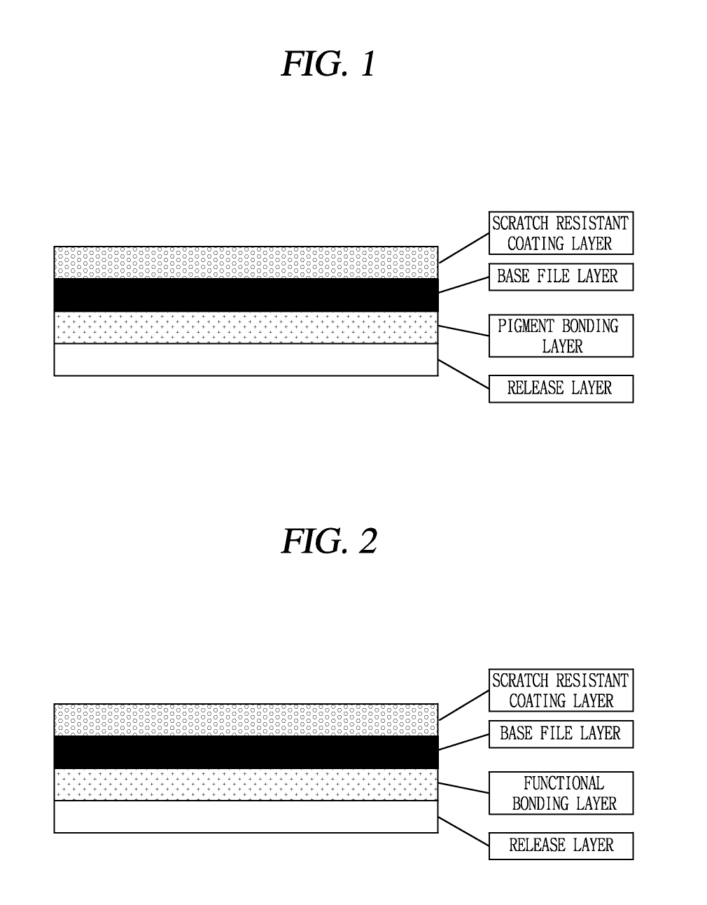

### DETAILED DESCRIPTION OF THE DISCLOSURE

Description will now be given in detail of the exemplary embodiments, with reference to the accompanying drawings. For the sake of brief description with reference to the drawings, the same or equivalent components will be provided with the same reference numbers, and description thereof will not be repeated.

Hereinafter, an adhesive in which a pigment material and a metal oxide are mixed and a colorable heat ray screening carbon-ceramic film using the same according to the present disclosure will be described in more detail through the detailed description of the Examples with reference to the drawings. In the description of the present disclosure, when it is determined that the detailed description for the related known technology or configuration can unnecessarily obscure the gist of the present disclosure, the detailed description thereof will be omitted. In addition, terms to be described below are terms defined in consideration of functions in the present disclosure, and these may vary depending on the intention or practice of a client or operator, and a user. Therefore, such terms should be defined based on the entire content disclosed in the present specification. Like numerals throughout the drawings indicate like elements.

The adhesive in which the pigment material and the metal oxide are mixed according to the present disclosure includes 20 to 90 wt % of the pigment material adhesive and 10 to 80 wt % of the metal oxide adhesive with respect to the total weight of the adhesive in which the pigment material and the metal oxide are mixed. Herein, when the pigment material adhesive is present in an amount of less than 20 wt % with respect to the total weight of the adhesive in which the pigment material and the metal oxide are mixed, there is a problem in that the coloring efficiency is reduced, and thus the aesthetic integrity deteriorates, and when the pigment material adhesive is present in an amount of more than 90 wt % with respect to the total weight of the adhesive in which the pigment material and the metal oxide are mixed, there is a problem in that the infrared ray screening efficiency is reduced. Further, when the metal oxide adhesive is present in an amount of less than 10 wt % with respect to the total weight of the adhesive in which the pigment material and the metal oxide are mixed, there is a problem in that the infrared ray screening efficiency is reduced, and when the metal oxide adhesive is present in an amount of more than 80 wt % with respect to the total weight of the adhesive in which the pigment material and the metal oxide are mixed, there is a problem in that the color of the metal oxide is so strong that the aesthetic integrity deteriorates.

Meanwhile, the pigment material adhesive includes 1 to 50 wt % of a pigment dispersion and 50 to 99 wt % of a glue material with respect to the total weight of the pigment material adhesive, in which the pigment dispersion includes 1 to 10 wt % of carbon black, 1 to 10 wt % of a pigment, 5 to 20 wt % of a dispersant, and 65 to 85 wt % of an organic solvent with respect to the total weight of the pigment dispersion. Herein, when the content of the pigment dispersion is less than 1 wt % with respect to the total weight of the pigment material adhesive, there is a problem in that the coloring efficiency is poor, and when the content of the pigment dispersion is more than 50 wt % with respect to the total weight of the pigment material adhesive, there is a problem in that the bonding efficiency is reduced.

Further, when the content of the glue material is less than 50 wt % with respect to the total weight of the pigment material adhesive, there is a problem in that the bonding efficiency is reduced, and when the content of the adhesive is more than 99 wt % with respect to the total weight of the pigment material adhesive, there is a problem in that the coloring efficiency is poor, and the preferred contents of the pigment dispersion and the adhesive are 5 to 30 wt % and 70 to 95 wt %, respectively. In addition, the carbon black serves to screen infrared rays while imparting color to the film. When the content of the carbon black is less than 1 wt % with respect to the total weight of the pigment dispersion, there is a problem in that the infrared ray screening efficiency is reduced, and when the content of the carbon black is more than 10 wt % with respect to the total weight of the pigment dispersion, there is a problem in that the inherent color of the carbon black is so strong that the aesthetic integrity of coloration deteriorates.

Furthermore, when the content of a pigment is less than 1 wt % with respect to the total weight of the pigment dispersion, there is a problem in that the inherent color of the carbon black is so strong that the aesthetic integrity of coloration deteriorates, and when the content of the pigment is more than 10 wt % with respect to the total weight of the pigment dispersion, there is a problem in that the infrared ray screening efficiency is reduced. The pigment is not particularly limited, but it is preferred that at least one or more are selected from the group consisting of Phthalocyanine Blue and Vermilion Red.

Further, the dispersant disperses the carbon black and the pigment well, and only when the carbon black and the pigment are well dispersed in the adhesive, the infrared ray screening efficiency is increased, and the turbidity of the pigment adhesive layer is low, thereby increasing the utility of a colored film. When the content of the dispersant is less than 5 wt % with respect to the total weight of the pigment dispersion, there is a problem in that the dispersibility of the carbon black and the pigment deteriorates, and when the content of the dispersant is more than 20 wt % with respect to the total weight of the pigment dispersion, there is a problem in that inherent physical properties of the adhesive deteriorate. The dispersant is preferably an acrylic dispersant. It is preferred that for the acrylic dispersant, at least one or more are selected from the group consisting of a terpolymer of 2-ethylhexyl acrylate, methacryl 2-hydroxyl acrylate, methacrylic acid, and tetrabutylammonium 3-chlorobenzoate.

In addition, when the content of the organic solvent is less than 65 wt % with respect to the total weight of the pigment dispersion, there is a problem in that the dispersibility of the carbon black and a pigment deteriorates, and thus, the turbidity is increased, and when the content of the organic solvent is more than 85 wt % with respect to the total weight of the pigment dispersion, the viscosity is so low that a problem with coatability occurs. It is preferred that for the organic solvent, at least one or more are selected from the group consisting of methyl ethyl ketone and ethyl acetate, and the methyl ethyl ketone and ethyl acetate have good compatibility with the carbon black and the pigment as well as with the adhesive. Herein, the particle size of the pigment contained in the pigment dispersion is 5 to 100 nm, but more preferably 40 nm to 80 nm in order to minimize the generation of haze. When the particle size of the pigment is less than 5 nm, the pigment conglomeration is fast and the dispersion stability deteriorates when the adhesive is mixed, and thus there is a problem in that the possibility of re-aggregation is high. When the particle size of the pigment is more than 100 nm, there is a problem in that haze is increased due to light scattering by particles present in a film to be manufactured.

Meanwhile, the metal oxide adhesive includes 1 to 60 wt % of the metal oxide dispersion and 40 to 99 wt % of a glue material with respect to the total weight of the metal oxide adhesive, in which the metal oxide dispersion includes 1 to 40 wt % of the metal oxide, 5 to 30 wt % of the dispersant, and 30 to 85 wt % of the organic solvent with respect to the total weight of the metal oxide dispersion. Herein, when the content of the metal oxide dispersion is less than 1 wt % with respect to the total weight of the metal oxide adhesive, there is a problem in that the coloring efficiency is poor, and thus the infrared ray screening efficiency is reduced. When the content of the metal oxide dispersion is more than 60 wt % with respect to the total weight of the metal oxide adhesive, there is a problem in that the self-aggregation occurs and the dispersion stability deteriorates.

Furthermore, when the content of the glue material is less than 40 wt % with respect to the total weight of the metal oxide adhesive, there is a problem in that the bonding efficiency is reduced. When the content of the glue material is more than 99 wt % with respect to the total weight of the metal oxide adhesive, there is a problem in that the infrared ray screening efficiency is reduced. Further, when the content of the metal oxide is less than 1 wt % with respect to the total weight of the metal oxide dispersion, there is a problem in that the infrared ray screening efficiency is reduced, and when the content of the metal oxide is more than 40 wt % with respect to the total weight of the metal oxide dispersion, there is a problem in that the dispersion efficiency is reduced. It is preferred that for the metal oxide, at least one or more members are selected from the group consisting of antimony oxide and tin oxide. The antimony oxide and the tin oxide serve to screen infrared rays.

In addition, when the content of a dispersant is less than 5 wt % with respect to the total weight of a metal oxide dispersion, there is a problem in that the dispersibility deteriorates, and when the content of the dispersant is more than 30 wt % with respect to the total weight of the metal oxide dispersion, there is a problem in that when an adhesive is mixed, the physical properties of the adhesive deteriorate. Furthermore, when the content of an organic solvent is less than 30 wt % with respect to the total weight of the metal oxide dispersion, there is a problem in that the dispersbility deteriorates, and when the content of the organic solvent is more than 85 wt % with respect to the total weight of the metal oxide dispersion, there is a problem in that the solid content is reduced, and thus the coloring efficiency is reduced. It is preferred that for the organic solvent, at least one or more are selected from the group consisting of isopropyl alcohol and ethyl acetate.

Herein, the particle size of the metal oxide used in the present disclosure is 5 to 100 nm, but more preferably 20 to 60 nm in order to minimize the generation of haze. When the particle size of the metal oxide is less than 5 nm, the conglomeration is fast and it is difficult to maintain the stability when the metal oxide is mixed. When the particle size of the metal oxide is more than 100 nm, there is a problem in that the haze of the film to be manufactured is increased, and thus light scattering occurs. Hereinafter, an adhesive in which a pigment material and a metal oxide are mixed according to the present disclosure and a colorable heat ray screening carbon-ceramic film using the same will be described.

The colorable heat ray screening carbon-ceramic film according to the present disclosure includes a base film layer, a functional bonding layer composed of a carbon-ceramic adhesive in which a pigment material and a metal oxide are mixed, and a transparent adhesive layer from the top. The colorable heat ray screening carbon-ceramic film of the present disclosure may further include one or more of a base film layer and a transparent adhesive layer which are sequentially stacked on the lower portion of the functional bonding layer. In the colorable heat ray screening carbon-ceramic film according to the present disclosure, a metal film may be used as the base film layer.

When the metal film is used, heat is insulated by blocking solar heat, privacy is protected by preventing transillumination from outside to inside, and visual field from inside to outside is cleared. As the metal film, a film such as an aluminum thin film coating is preferably used. In the colorable heat ray screening carbon-ceramic film according to the present disclosure, the base film layer may employ any material typically used in the art, and it is preferred that the base film layer is composed of polyethylene, polypropylene, polyethylene terephthalate, polyester, polycarbonate, polyvinyl chloride, polyvinylidene chloride, polystyrene, or polyamide.

In the present disclosure, the adhesive may be made by any combination of a UV absorber with a pressure sensitive adhesive (PSA), a heat sensitive adhesive, and a self-adhesive. In the present disclosure, the PSA used in the transparent adhesive layer is not particularly limited as long as the PSA is typically used in the art, and for example, various PSAs, such as acrylic, rubber-based, polyvinyl ether-based, and silicone-based PSAs, may be used. Specifically, the acrylic PSA may be obtained by copolymerizing a (meth)acrylic acid ester having an alkyl group with a polymerizable unsaturated carbonic acid, a hydroxyl group-containing ethylenically unsaturated monomer, or a copolymerizable vinyl monomer in an organic solvent.

In the present disclosure, the heat sensitive adhesive used in the transparent adhesive layer refers to an adhesive which has low adhesiveness at normal temperature, but exhibits adhesiveness by heating, and also refers to a hot-melt adhesive or heat sealing agent. The heat sensitive adhesive is not particularly limited as long as the heat sensitive adhesive is typically used in the art, and examples thereof include heat sensitive adhesives which employ an ethylene-vinyl acetate copolymer, an ethylene-ethyl acrylate copolymer, an ethylene-acrylic acid copolymer, a polyamide-based resin, a polyimide-based resin, a polyester-based resin, a rubber-based styrene-butadiene-styrene copolymer, a rubber-based styrene-isoprene-styrene copolymer and the like as a base polymer.

In the present disclosure, a self-adhesive used in the transparent adhesive layer may achieve bonding with a flat, smooth adherent by using air tightness between the adhesive (self-adhesive) surface and the smooth surface of the adherent; the adhesive sheet itself and the adherend may be easily peeled off without being contaminated; and it may be possible to achieve bonding repeatedly. The self-adhesive as described above is not also particularly limited as long as the self-adhesive is typically used in the art, and examples thereof include an ethylene-based copolymer such as an ethylene-vinyl acetate copolymer and an ethylene-ethyl acrylate copolymer, an ethylene-α-olefin copolymer, a soft vinyl chloride-based resin, an acrylic resin, a rubber-based resin, a urethane-based resin, an olefin-based resin, and the like.

Further, in the colorable heat ray screening carbon-ceramic film according to the present disclosure, a scratch resistant coating layer may be further included on the upper portion of the base film layer. The colorable heat ray screening carbon-ceramic film according to the present disclosure may have a 1-play structure, and even a 3-ply structure.

FIG. 2 illustrates a cross-sectional view of a colorable heat ray screening carbon-ceramic film having a 1-ply structure. In FIG. 2, a scratch resistant coating layer, a functional bonding layer composed of a carbon-ceramic adhesive in which a pigment material and a metal oxide are mixed, and a transparent adhesive layer are sequentially stacked from the top. It may be necessary for a release layer to be provided on the lower portion of the transparent adhesive layer. As the release layer, a release sheet such as a resin film or paper may be used.

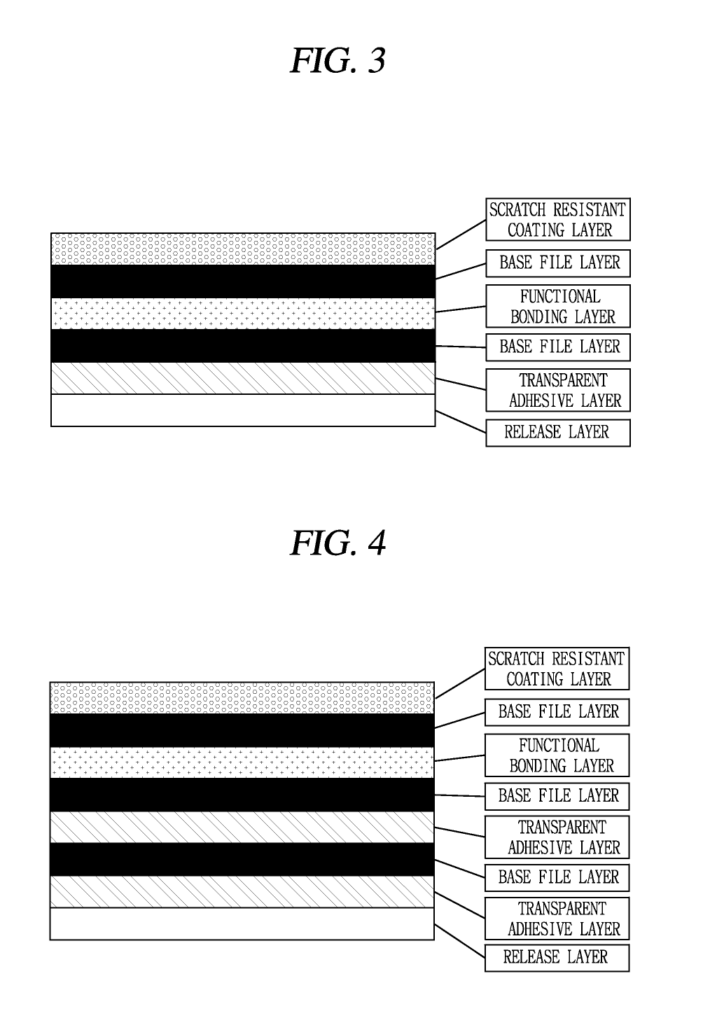

FIG. 3 illustrates a cross-sectional view of a colorable heat ray screening carbon-ceramic film having a 2-ply structure. In FIG. 3, a scratch resistant coating layer, a base film layer, a functional bonding layer composed of a carbon-ceramic adhesive in which a pigment material and a metal oxide are mixed, a base film layer, a transparent adhesive layer, and a release layer are sequentially stacked from the top.

FIG. 4 illustrates a cross-sectional view of a colorable heat ray screening carbon-ceramic film having a 3-ply structure. In FIG. 4, a scratch resistant coating layer, a base film layer, a functional bonding layer composed of a carbon-ceramic adhesive in which a pigment material and a metal oxide are mixed, a base film layer, a transparent adhesive layer, a base film layer, a transparent adhesive layer, and a release layer are sequentially stacked from the top. Herein, the scratch resistant coating layer has a thickness of 1 to 2 μm, the base film layer has a thickness of 12 to 250 μm, the functional bonding layer has a thickness of 1 to 10 μm, the transparent adhesive layer has a thickness of 1 to 25 μm, and the release layer has a thickness of 23 μm.

Hereinafter, the weatherability for each type of film will be exhibited, and the results are shown in the following Table 1.

TABLE 1

| Type of Film | Coating Material | Weatherability |
|---|---|---|
| Carbon-Ceramic Film | Hybrid Organic Pigment & | ⊚ |
| | Inorganic Oxide Material | |
| Pigment (Carbon) Film | Organic Pigment | ⊚ |
| Ceramic Film | Inorganic Oxide Material | Δ |
| Dye Coating Film | Organic Dye | Δ |
| Dyed Film | Organic Dye | X |
| Metal Film | Metal | X |

Herein, ⊚, Δ, and x mean excellent, fair, and bad, respectively. As can be seen from Table 1, it can be seen that the carbon-ceramic film and the carbon film have excellent weatherability.

Hereinafter, the weatherability results according to the time passage for each type of film will be shown, and the results are as in the following Table 2.

TABLE 2

| Type of Film and | 100 | 200 | 300 | 400 | 500 | 600 | 700 | 800 | 900 | 1,000 |
|---|---|---|---|---|---|---|---|---|---|---|
| Passage Time | hr | hr | hr | hr | hr | hr | hr | hr | hr | hr |
| CC#1 Film | 0.23 | 0.27 | 0.37 | 0.50 | 0.58 | 0.60 | 0.76 | 0.81 | 0.84 | 0.89 |
| CC#2 Film | 0.19 | 0.31 | 0.49 | 0.59 | 0.74 | 0.84 | 1.10 | 1.11 | 1.13 | 1.14 |
| Pigment Film | 0.14 | 0.33 | 0.40 | 0.35 | 0.58 | 0.58 | 0.58 | 0.79 | 0.77 | 0.81 |
| Ceramic Film | 0.37 | 0.49 | 0.73 | 1.06 | 1.16 | 1.47 | 1.55 | 2.18 | 2.59 | 2.67 |
| Dye Film | 2.78 | 4.60 | 4.70 | 4.77 | 5.11 | 5.56 | 6.11 | 6.72 | 7.44 | 7.97 |
| Dye Film | 2.28 | 3.02 | 3.67 | 4.77 | 5.39 | 5.71 | 6.35 | 6.80 | 7.42 | 7.81 |
| Dyed Film | 1.29 | 2.29 | 2.91 | 3.65 | 4.22 | 4.43 | 4.58 | 4.97 | 4.94 | 4.84 |
| Metal Film | 1.36 | 2.22 | 2.25 | 2.74 | 2.84 | 3.10 | 3.34 | 3.56 | 3.81 | 4.28 |

In FIG. 2, the degree of discoloration is Δ E*ab, the weatherability test method is Q-Lab corporation, Q-Sun Zenon Tester ISO 4892-2. Herein, “CC” is Carbon-Ceramic. As illustrated in Table 2, it can be seen that the carbon-ceramic films (CC#1, CC#2) have excellent weatherability compared to the other films in spite of the passage of time.

Hereinafter, haze for each film manufacturer will be exhibited, and the results are as in the following Table 3.

TABLE 3

| Classification | Product Name | Haze |
|---|---|---|
| Present Disclosure | Carbon-Ceramic Film-1 | 0.72 |
| | Carbon-Ceramic Film-2 | 0.71 |
| | Carbon-Ceramic Film-3 | 0.94 |
| | Carbon-Ceramic Film-4 | 0.87 |
| | Carbon-Ceramic Film-5 | 0.91 |
| | Carbon-Ceramic Film-6 | 0.8 |
| A Company | Dyed Film-1 | 1.18 |
| | Dyed Film-2 | 1.27 |
| | Dyed Film-3 | 1.1 |
| | Dyed Film-4 | 1.18 |
| B Company | Metal Film-1 | 2.02 |
| | Metal Film-2 | 1.25 |
| C Company | Metal + Dyed Film | 2.08 |

The experimental method was measured while modifying the particle sizes, and as can be seen from Table 3, it can be seen that the carbon-ceramic film of the present disclosure has the lowest haze.

Hereinafter, the test results of detecting heavy metals of the colorable heat ray screening carbon-ceramic film according to the present disclosure will be shown, and the results are as in the following Table 4.

TABLE 4

| | | Test | | |
|---|---|---|---|---|
| Test Item | Unit | Result | Test Method | |
| Cadmium (Cd) | mg/kg | N.D. | IEC 62321 | : 2008, ICP |
| Lead (Pb) | mg/kg | N.D. | IEC 62321 | : 2008, ICP |
| Mercury (Hg) | mg/kg | N.D. | IEC 62321 | : 2008, ICP |
| Hexavalent Chromium | mg/kg | N.D. | IEC 62321 | : 2008, UV-VIS |
| (Cr VI) | | | | |

As can be seen from Table 4, no heavy metal was detected from the colorable heat ray screening carbon-ceramic film according to the present disclosure.

Hereinafter, the test results of releasing toxic materials of the colorable heat ray screening carbon-ceramic film according to the present disclosure will be shown, and the results are as in the following Table 5.

TABLE 5

| | | Test | |
|---|---|---|---|
| Test Item | Unit | Result | Test Method |
| Total Volatile Organic | mg/m²h | N.D. | Indoor Air Quality Process |
| Compound (TVOC) | | | Test Standard (Public Notice |
| | | | of Ministry of Environment |
| | | | No. 2010-24) |
| Toluene | mg/m²h | N.D. | Indoor Air Quality Process |
| | | | Test Standard (Public Notice |
| | | | of Ministry of Environment |
| | | | No. 2010-24) |
| Formaldehyde | mg/m²h | N.D. | Indoor Air Quality Process |
| | | | Test Standard (Public Notice |
| | | | of Ministry of Environment |
| | | | No. 2010-24) |

As can be seen from Table 5, no toxic material was released from the colorable heat ray screening carbon-ceramic film according to the present disclosure.

The colorable heat ray screening carbon-ceramic film according to the present disclosure may add a sensory performance through a selective light screening by incorporating a selective screening material into the scratch resistant coating layer and the pigment coating. No further process is added by maintaining the general 2 play 3 process, and there is no change in the thickness of the product by achieving a functional coating without a change in the thickness of the base film. As described above, the adhesive in which the pigment material and the metal oxide are mixed according to the present disclosure and the colorable heat ray screening carbon-ceramic film using the same may provide a pigment material adhesive for manufacturing a pigment colored film having a low haze by using a functional adhesive in which a pigment material adhesive and a metal oxide adhesive are mixed. In addition, it may be possible to provide the pigment material adhesive for manufacturing the pigment colored film having a good light resistance and excellent infrared ray screening properties. Furthermore, the number of processes may provide the pigment material adhesive for manufacturing the pigment colored film in which convenience and efficiency of the process are improved.

As described above, the present disclosure has been described based on good examples, but since these examples do not intent to limit the present disclosure, but intend to exemplify the present disclosure, various modifications or changes or adjustments can be made to the examples by a person with ordinary skill in the art without departing from the technical spirit of the present disclosure. Therefore, the protection scope of the present disclosure should be interpreted to encompass all modification examples, change examples, or adjustment examples, which belong to the gist of technical spirit of the present disclosure.

The foregoing embodiments and advantages are merely exemplary and are not to be considered as limiting the present disclosure. The present teachings can be readily applied to other types of apparatuses. This description is intended to be illustrative, and not to limit the scope of the claims. Many alternatives, modifications, and variations will be apparent to those skilled in the art. The features, structures, methods, and other characteristics of the exemplary embodiments described herein may be combined in various ways to obtain additional and/or alternative exemplary embodiments. As the present features may be embodied in several forms without departing from the characteristics thereof, it should also be understood that the above-described embodiments are not limited by any of the details of the foregoing description, unless otherwise specified, but rather should be considered broadly within its scope as defined in the appended claims, and therefore all changes and modifications that fall within the metes and bounds of the claims, or equivalents of such metes and bounds are therefore intended to be embraced by the appended claims.

What is claimed is:

1. An adhesive in which a pigment material and a metal oxide are mixed, the adhesive comprising: 20 to 90 wt % of a pigment material adhesive and 10 to 80 wt % of a metal oxide adhesive with respect to a total weight of the adhesive in which the pigment material and the metal oxide are mixed;
wherein the pigment material adhesive comprises 1 to 50 wt % of a pigment dispersion and 50 to 99 wt % of a glue material with respect to a total weight of the pigment material adhesive; and
the metal oxide adhesive comprises 1 to 60 wt % of a metal oxide dispersion and 40 to 99 wt % of the glue material with respect to a total weight of the metal oxide adhesive.

2. The adhesive of claim 1, wherein the pigment dispersion comprises 1 to 10 wt % of carbon black, 1 to 10 wt % of a pigment, 5 to 20 wt % of a dispersant, and 65 to 85 wt % of an organic solvent with respect to a total weight of the pigment dispersion.

3. The adhesive of claim 2, wherein the metal oxide dispersion comprises 1 to 40 wt % of the metal oxide, 5 to 30 wt % of a dispersant, and 30 to 85 wt % of an organic solvent with respect to a total weight of the metal oxide dispersion

4. The adhesive of claim 1, wherein for the pigment, at least one or more members are selected from the group consisting of Phthalocyanine Blue and Vermilion Red.

5. The adhesive of claim 4, wherein the pigment has a particle size of 5 to 100 nm.

6. The adhesive of claim 1, wherein for the metal oxide, at least one or more members are selected from the group consisting of antimony oxide and tin oxide.

7. The adhesive of claim 6, wherein the metal oxide has a particle size of 5 to 100 nm.

8. The adhesive of claim 1, wherein the adhesive is composed of a mixture of a UV absorber with a pressure sensitive adhesive, a heat sensitive adhesive, or a self-adhesive.

9. The adhesive of claim 1, wherein for the organic solvent, at least one or more members are selected from the group consisting of methyl ethyl ketone and ethyl acetate.

10. A colorable heat ray screening carbon-ceramic film comprising a base film layer, and a functional bonding layer composed of the adhesive of claim 1, from the top.

11. The colorable heat ray screening carbon-ceramic film of claim 10, further comprising one or more of a base film layer and a transparent adhesive layer which are sequentially stacked on a lower portion of the functional bonding layer.

12. The colorable heat ray screening carbon-ceramic film of claim 10, further comprising a scratch resistant layer on a upper portion of the base film layer.

13. The colorable heat ray screening carbon-ceramic film of claim 10, wherein the base film layer is composed of polyethylene, polypropylene, polyethylene terephthalate, polyester, polycarbonate, polyvinyl chloride, polyvinylidene chloride, polystyrene, or polyamide.

14. A colorable heat ray screening carbon-ceramic film comprising a base film layer, and a functional bonding layer composed of the adhesive of claim 3, from the top.

15. The colorable heat ray screening carbon-ceramic film of claim 14, further comprising one or more of a base film layer and a transparent adhesive layer which are sequentially stacked on a lower portion of the functional bonding layer.

16. The colorable heat ray screening carbon-ceramic film of claim 14, further comprising a scratch resistant layer on a upper portion of the base film layer.

17. The colorable heat ray screening carbon-ceramic film of claim 14, wherein the base film layer is composed of polyethylene, polypropylene, polyethylene terephthalate, polyester, polycarbonate, polyvinyl chloride, polyvinylidene chloride, polystyrene, or polyamide.
